(19) United States
(12) Patent Application Publication
(10) Pub. No.: US 2026/0230380 A1
(43) Pub. Date: Aug. 6, 2026

(54) REPORTING MEASUREMENT INFORMATION

(71) Applicant: Lenovo (United States) Inc., Morrisville, NC (US)

(72) Inventors: Vahid Pourahmadi, München (DE); Tapisha Soni, Munich (DE); Joachim Löhr, Wiesbaden (DE)

(73) Assignee: Lenovo (United States) Inc., Morrisville, NC (US)

(21) Appl. No.: 19/047,616

(22) Filed: Feb. 6, 2025

(51) Int. Cl. H04L 41/082; H04L 41/084; H04W 24/10

(52) U.S. Cl. CPC H04L 41/082; H04L 41/084; H04W 24/10

(57) ABSTRACT

Various aspects of the present disclosure relate to reporting measurement information. A UE may receive, from a NE, configuration information for measurement and/or reporting. The configuration information indicates whether the UE is allowed to request an update for one or more parameters associated with the measurement and/or reporting, or initiate an update for one or more of the parameters. The UE may transmit, to the NE, an update request to change the one or more parameters associated with the measurement and/or reporting. The UE may transmit an update notification to change the one or more parameters associated with the measurement and/or reporting, or a selection of a pre-configured configuration from a set of pre-configured configurations. The UE may perform measurements based on the update and without notifying the NE of the update, and a measurement report is transmitted without notifying the NE of the update.

### TECHNICAL FIELD

The present disclosure relates to wireless communications, and more specifically to measurement information reporting between devices.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive, from a NE, configuration information for at least one of measurement or reporting, where the configuration information indicates whether the UE is allowed to request an update for one or more parameters associated with at least one of the measurement or reporting; and transmit, to the NE, an update request to change the one or more parameters associated with at least one of the measurement or reporting.

A processor (e.g., a standalone processor chipset, or a component of a UE) for wireless communication is described. The processor may be configured to, capable of, or operable to perform one or more operations as described herein. For example, the processor may be configured to, capable of, or operable to receive, from a NE, configuration information for at least one of measurement or reporting, where the configuration information indicates whether a UE is allowed to request an update for one or more parameters associated with at least one of the measurement or reporting; and transmit, to the NE, an update request to change the one or more parameters associated with at least one of the measurement or reporting.

A method performed or performable by a UE for wireless communication is described. The method may include receiving, from a NE, configuration information for at least one of measurement or reporting, where the configuration information indicates whether the UE is allowed to request an update for one or more parameters associated with at least one of the measurement or reporting; and transmitting, to the NE, an update request to change the one or more parameters associated with at least one of the measurement or reporting.

In some implementations of the UE, the processor, and the method described herein, the UE, the processor, and the method may be configured to, capable of, or operable to receive, from the NE, updated configuration information based on the update request, the updated configuration information for at least one of updated measurement or updated reporting. In some implementations of the UE, the processor, and the method described herein, the UE has a set of pre-configured configurations, and the UE, the processor, and the method may be configured to, capable of, or operable to select a pre-configured configuration from the set of pre-configured configurations; and transmit the update request associated with the selected pre-configured configuration.

In some implementations of the UE, the processor, and the method described herein, the UE, the processor, and the method may be configured to, capable of, or operable to select the pre-configured configuration from the set of pre-configured configurations based on current measurement results; and transmit the update request indicating the selected pre-configured configuration. In some implementations of the UE, the processor, and the method described herein, the update request indicates a change in periodicity of reporting measurement results. In some implementations of the UE, the processor, and the method described herein, the UE, the processor, and the method may be configured to, capable of, or operable to transmit, to the NE, a measurement report of measurement results and a validity period associated with the measured results, where the validity period is a time duration after which the UE expects a change in reported measurement results. In some implementations of the UE, the processor, and the method described herein, the UE, the processor, and the method may be configured to, capable of, or operable to transmit, to the NE, a measurement report of measurement results and a confidence value that indicates a likelihood of change in subsequent measurement results.

A UE for wireless communication is described. The UE may be configured to, capable of, or operable to perform one or more operations as described herein. For example, the UE may be configured to, capable of, or operable to receive, from a NE, configuration information for at least one of measurement or reporting, where the configuration information indicates whether the UE is allowed to initiate an update for one or more parameters associated with at least one of the measurement or reporting; and transmit, to the NE, at least one of an update notification to change the one or more parameters associated with at least one of the measurement or reporting, or a selection of a pre-configured configuration from a set of pre-configured configurations.

A processor (e.g., a standalone processor chipset, or a component of a UE) for wireless communication is described. The processor may be configured to, capable of, or operable to perform one or more operations as described herein. For example, the processor may be configured to, capable of, or operable to receive, from a NE, configuration information for at least one of measurement or reporting, where the configuration information indicates whether a UE is allowed to initiate an update for one or more parameters associated with at least one of the measurement or reporting; and transmit, to the NE, at least one of an update notification to change the one or more parameters associated with at least one of the measurement or reporting, or a selection of a pre-configured configuration from a set of pre-configured configurations.

A method performed or performable by a UE for wireless communication is described. The method may include receiving, from a NE, configuration information for at least one of measurement or reporting, where the configuration information indicates whether the UE is allowed to initiate an update for one or more parameters associated with at least one of the measurement or reporting; and transmitting, to the NE, at least one of an update notification to change the one or more parameters associated with at least one of the measurement or reporting, or a selection of a pre-configured configuration from a set of pre-configured configurations.

In some implementations of the UE, the processor, and the method described herein, the UE, the processor, and the method may be configured to, capable of, or operable to select the pre-configured configuration from the set of pre-configured configurations based on current measurement results. In some implementations of the UE, the processor, and the method described herein, the configuration information includes a timing delay, and the UE, the processor, and the method may be configured to, capable of, or operable to transmit, to the NE, the update notification, and wait a time duration of the timing delay before at least one of continuing measurements or reporting measurements results based on the update notification.

In some implementations of the UE, the processor, and the method described herein, the UE, the processor, and the method may be configured to, capable of, or operable to start a timer to wait the timing delay, where the timer is started based on a confirmation that the NE received the update notification. In some implementations of the UE, the processor, and the method described herein, the UE, the processor, and the method may be configured to, capable of, or operable to receive hybrid automatic repeat request (HARQ) feedback as the confirmation that the NE received the update notification.

A UE for wireless communication is described. The UE may be configured to, capable of, or operable to perform one or more operations as described herein. For example, the UE may be configured to, capable of, or operable to receive, from a NE, configuration information for at least one of measurement or reporting, where the configuration information indicates whether the UE is allowed to initiate an update for one or more parameters associated with at least one of the measurement or reporting, or select a pre-configured configuration from a set of pre-configured configurations; perform measurements based on the update and without notifying the NE of the update; and transmit, to the NE, a measurement report of measurement results, where the measurement report is transmitted without notifying the NE of the update.

A processor (e.g., a standalone processor chipset, or a component of a UE) for wireless communication is described. The processor may be configured to, capable of, or operable to perform one or more operations as described herein. For example, the processor may be configured to, capable of, or operable to receive, from a NE, configuration information for at least one of measurement or reporting, where the configuration information indicates whether a UE is allowed to initiate an update for one or more parameters associated with at least one of the measurement or reporting, or select a pre-configured configuration from a set of pre-configured configurations; perform measurements based on the update and without notifying the NE of the update; and transmit, to the NE, a measurement report of measurement results, where the measurement report is transmitted without notifying the NE of the update.

A method performed or performable by a UE for wireless communication is described. The method may include receiving, from a NE, configuration information for at least one of measurement or reporting, where the configuration information indicates whether the UE is allowed to initiate an update for one or more parameters associated with at least one of the measurement or reporting, or select a pre-configured configuration from a set of pre-configured configurations; performing measurements based on the update and without notifying the NE of the update; and transmitting, to the NE, a measurement report of measurement results, where the measurement report is transmitted without notifying the NE of the update.

In some implementations of the UE, the processor, and the method described herein, the configuration information includes a set of configuration rules by which the UE and the NE initiate the update. In some implementations of the UE, the processor, and the method described herein, the configuration information includes a timing delay, and the UE, the processor, and the method may be configured to, capable of, or operable to perform the measurements based on the configuration information before the update; and transmit, to the NE, an initial measurement report, and wait a time duration of the timing delay before at least one of continuing measurements or reporting measurement results based on the change notification.

In some implementations of the UE, the processor, and the method described herein, the UE, the processor, and the method may be configured to, capable of, or operable to start a timer to wait the timing delay, where the timer is started based on a confirmation that the NE received the initial measurement report. In some implementations of the UE, the processor, and the method described herein, the UE, the processor, and the method may be configured to, capable of, or operable to receive HARQ feedback as the confirmation that the NE received the initial measurement report.

An NE (e.g., a base station, gNB) for wireless communication is described. The NE may be configured to, capable of, or operable to perform one or more operations as described herein. For example, the NE may be configured to, capable of, or operable to transmit, to a UE, configuration information for one or more of at least one of measurement or reporting, a set of pre-configured configurations, or a set of configuration rules, where the configuration information indicates whether the UE is allowed to at least one of request an update for one or more parameters associated with at least one of the measurement or reporting, or initiate the update; and one of: for a requested update, receive from the UE, an update request to change the one or more parameters associated with at least one of the measurement or reporting; for a notified update, receive from the UE, an update notification to change the one or more parameters associated with at least one of the measurement or reporting, or an update of measurement results; or for an initiated update, receive from the UE, a measurement report of measurement results, where the measurement report is received by the NE without notification of the initiated update.

A processor (e.g., a standalone processor chipset, or a component of a NE) for wireless communication is described. The processor may be configured to, capable of, or operable to perform one or more operations as described herein. For example, the processor may be configured to, capable of, or operable to transmit, to a UE, configuration information for one or more of at least one of measurement or reporting, a set of pre-configured configurations, or a set of configuration rules, where the configuration information indicates whether the UE is allowed to at least one of request an update for one or more parameters associated with at least one of the measurement or reporting, or initiate the update; and one of: for a requested update, receive from the UE, an update request to change the one or more parameters associated with at least one of the measurement or reporting; for a notified update, receive from the UE, an update notification to change the one or more parameters associated with at least one of the measurement or reporting, or an update of measurement results; or for an initiated update, receive from the UE, a measurement report of measurement results, where the measurement report is received without notification of the initiated update.

A method performed or performable by an NE (e.g., a base station, gNB) for wireless communication is described. The method may include transmitting, to a UE, configuration information for one or more of at least one of measurement or reporting, a set of pre-configured configurations, or a set of configuration rules, where the configuration information indicates whether the UE is allowed to at least one of request an update for one or more parameters associated with at least one of the measurement or reporting, or initiate the update; and one of: for a requested update, receiving from the UE, an update request to change the one or more parameters associated with at least one of the measurement or reporting; for a notified update, receiving from the UE, an update notification to change the one or more parameters associated with at least one of the measurement or reporting, or an update of measurement results; or for an initiated update, receiving from the UE, a measurement report of measurement results, where the measurement report is received by the NE without notification of the initiated update.

In some implementations of the NE, the processor, and the method described herein, the update request or the update notification indicates whether the UE selected a pre-configured configuration from the set of pre-configured configurations. In some implementations of the NE, the processor, and the method described herein, the NE, the processor, and the method may be configured to, capable of, or operable to determine, based on the measurement report and the set of configuration rules, that the UE updated the one or more parameters associated with at least one of the measurement or reporting, or selected a different pre-configured configuration from the set of pre-configured configurations.

### BRIEF DESCRIPTION OF THE DRAWINGS

FIG. 1 illustrates an example of a wireless communications system in accordance with aspects of the present disclosure.

FIG. 2 illustrates an example information element (IE) for channel state information (CSI) report configuration (CSI-ReportConfig), in accordance with aspects of the present disclosure.

FIG. 3 illustrates example IEs for CSI-ReportConfig: periodic reporting, aperiodic reporting, and semi-persistent reporting, in accordance with aspects of the present disclosure.

FIG. 4 illustrates an example information report, in accordance with aspects of the present disclosure.

FIG. 5 illustrates an example measurement report, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by a UE in accordance with aspects of the present disclosure.

FIG. 10 illustrates a flowchart of a method performed by a UE in accordance with aspects of the present disclosure.

FIG. 11 illustrates a flowchart of a method performed by a UE in accordance with aspects of the present disclosure.

FIG. 12 illustrates a flowchart of a method performed by a NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. For example, network devices (e.g., the UE and the NE) in the wireless communications system may support transmitting and/or receiving signals. Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

The addition or application of artificial intelligence (AI) and/or machine learning (ML) models have been shown to improve performance in network devices. For example, implementations of AI/ML models in the physical (PHY) layer of communication links may improve device performance. However, due to the data-driven nature of these AI/ML models, and given that a trained model may have limited generalization capability, an AI/ML model that is performing well at a particular instance may exhibit a degraded, lower performance at another time. Accordingly, monitoring the performance of AI/ML models is an implementation task as part of the overall AI/ML life cycle management (LCM).

A procedure for monitoring the performance of an AI/ML model may depend on providing some measurement information that is only transmitted for the purpose of the monitoring. In an example, a UE may implement an AI/ML beam management (BM) model that determines or predicts a best transmission and/or reception beam from a set of possible beams by performing measurements over a set of beam directions. A determined or predicted best beam, as determined by an AI/ML BM model, can then be subsequently transmitted to an NE (e.g., a gNB). To monitor the performance of this AI/ML BM model, the NE may configure the UE to perform measurements on the set of possible beams and communicate that information to the NE. The NE can then monitor the performance of the AI/ML BM model that is implemented at the UE to determine the best possible beams.

In this example, the UE can perform the measurements and communicate the measurement information to the NE for monitoring the model performance. Taking into account signaling overhead considerations that may be incurred by the additional measurements and information communication, the NE may configure the UE for a lesser frequency of measuring and reporting in an effort to reduce and/or minimize impacts on the signaling overhead. Although a higher frequency of the measuring and reporting may provide a more accurate representation of the performance of the AI/ML BM model, the higher frequency would likely contribute to the increased overhead considerations. Aspects of the present disclosure are described in the context of a wireless communications system, and address AI/ML model performance monitoring and accuracy, while also maintaining the signaling overhead considerations within an acceptable operation range.

In another example, a network device or node, such as a UE, may implement an AI/ML model that generates and/or predicts information pertaining to a particular operation metric, or metrics. For example, an AI/ML model may be used to predict the probability of a radio link failure (RLF), which the UE is likely configured to communicate to the NE. To transmit, send, or otherwise communicate this information, the NE may have configured the UE to send the information periodically, with a certain periodicity. Alternatively, the UE may be implemented to request permission to send the predicted information, such as if a predicted RLF value is higher than a threshold and the UE schedules with the NE for reporting the information. This example may come with an undesirably high signaling overhead if the predicted RLF probability is reported too often, or may come with less overhead using less frequent reporting, yet with a higher chance of not detecting or missing the RLF. Accordingly, aspects of this disclosure are directed to implementations that balance AI/ML model measuring and reporting between exceeding signaling overhead expectations, yet maintaining detection accuracy.

In some measurement and reporting configurations, a UE may implement different conventional approaches for reporting measurement information to a NE (e.g., a gNB), such as periodic reporting, aperiodic reporting, and/or semi-persistent reporting. For periodic reporting, an NE may configure a UE to periodically report a metric (e.g., measurement information) with a certain period or frequency. With periodic reporting, the UE can provide regular updates of the measurement information, which may facilitate overhead load balancing and network operational efficiency. For aperiodic reporting, the NE may send a query message to the UE whenever it wants the UE to communicate the measurement information back to the NE. The aperiodic reporting may be used to provide more immediate information as to an aspect of an AI/ML model, and may be triggered by a more specific measurement event. For semi-persistent reporting, the NE may preconfigure one or more reporting configurations (for example, different configurations with different periodicities), and then activate or deactivate specific configurations whenever the NE wants a particular setting by communicating a message that requests the UE to start or stop sending messages to the NE based on one of the preconfigured reporting configurations.

In aspects of the described techniques, alternative reporting schemes may be implemented, such as for model (e.g., AI/ML model) monitoring and/or reporting of a prediction metric. Aspects of the described techniques in this disclosure offer solutions to the drawbacks of the current modes of CSI reporting for reporting measurement information to a NE (e.g., a gNB), as well as to balance signaling overhead and latency. The described techniques include a first implementation that provides a UE can request a change of the reporting (CSI reporting) method. A second implementation provides for a semi-autonomous change of the reporting (CSI reporting) method by a UE. A third implementation provides for a rule-based change of the reporting (CSI reporting) method by a UE.

These described solutions provide that a UE can determine whether a current state of the UE requires a different reporting configuration, and in particular, a different reporting periodicity. In one or more implementations, a UE reporting configuration can be updated to a new configuration that allows the UE to communicate a request for the new configuration that has a different reporting periodicity, or for selection of a different reporting configuration (e.g., in the case of semi-persistent reporting). Additionally, or alternatively, a UE reporting configuration may be updated to a new configuration that allows for UE reporting of another metric along with a measurement that indicates an estimated validity or confidence of the reported data. Additionally, or alternatively, new reporting configurations may also be implemented that enable a semi-autonomous change of the reporting configurations and/or a rule-based reporting configuration modification.

Aspects of the present disclosure are described in the context of a wireless communications system.

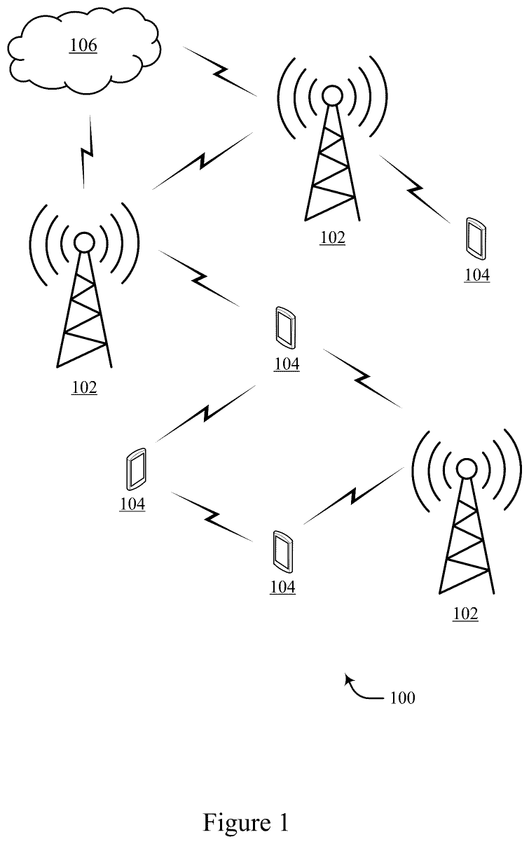

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Some wireless communications systems may support reporting measurement information between devices by implementing aspects of the techniques described herein. For example, an NE 102 and a UE 104 in the wireless communications system 100 may support the described reporting schemes, such as for model (e.g., AI/ML model) monitoring and/or reporting of a prediction metric. Aspects of the described techniques in this disclosure offer solutions to the drawbacks of the current modes of CSI reporting for reporting measurement information to a NE 102 (e.g., a gNB), as well as to balance signaling overhead and latency. The described techniques include a first implementation that provides a UE 104 can request a change of the reporting (CSI reporting) method. A second implementation provides for a semi-autonomous change of the reporting (CSI reporting) method by a UE. A third implementation provides for a rule-based change of the reporting (CSI reporting) method by a UE.

These described solutions provide that a UE 104 can determine whether a current state of the UE requires a different reporting configuration, and in particular, a different reporting periodicity. In one or more implementations, a UE reporting configuration can be updated to a new configuration that allows the UE 104 to communicate a request for the new configuration that has a different reporting periodicity, or for selection of a different reporting configuration (e.g., in the case of semi-persistent reporting). Additionally, or alternatively, a UE reporting configuration may be updated to a new configuration that allows for UE 104 reporting of another metric along with a measurement that indicates an estimated validity or confidence of the reported data. Additionally, or alternatively, new reporting configurations may also be implemented that enable a semi-autonomous change of the reporting configurations and/or a rule-based reporting configuration modification.

According to implementations, one or more of the NEs 102 and the UEs 104 are operable to implement various aspects of the techniques described with reference to the present disclosure. For example, a UE 104 receives, from a NE 102 (e.g., a gNB), configuration information that includes measurement parameters and reporting instructions. The configuration information can indicate that the UE 104 is allowed to request a configuration change. The UE 104 transmits, to the NE 102, the request for the configuration change that indicates a request to change at least one of the reporting instructions or the measurement parameters. In another example, a UE 104 receives, from a NE 102 (e.g., a gNB), configuration information that includes measurement parameters and reporting instructions. The configuration information can indicate that the UE 104 is allowed to initiate a configuration change. The UE 104 transmits, to the NE 102, a notification of the configuration change that indicates at least one of a change of the reporting instructions, a change of the measurement parameters, or a selection of a pre-configured configuration from a set of pre-configured configurations.

In another example, a UE 104 receives, from a NE 102 (e.g., a gNB), configuration information that includes measurement parameters and reporting instructions. The configuration information can indicate that the UE 104 is allowed to initiate a configuration change of at least one of the reporting instructions, the measurement parameters, or a selection of a pre-configured configuration from a set of pre-configured configurations. The UE 104 performs parameter measurements based on the configuration change and without notifying the NE of the configuration change. The UE 104 transmits, to the NE 102, a measurement report that includes measured parameter results, where the measurement report is transmitted without notifying the NE of the configuration change.

In another example, an NE 102 (e.g., a gNB) transmits, to a UE 104, configuration information that includes one or more of measurement parameters, reporting instructions, a set of pre-configured configurations, or a set of configuration rules. The configuration information can indicate that the UE is allowed to at least one of request a configuration change or initiate the configuration change. The NE 102 is further implemented to one of: for a requested configuration change, receive from the UE 104, the request for the configuration change that indicates a request to change at least one of the reporting instructions or the measurement parameters. For a notified configuration change, receive from the UE 104, a notification of the configuration change that indicates at least one of the change of the reporting instructions or the change of the measurement parameters. For an initiated configuration change, receive from the UE 104, a measurement report that includes measured parameter results, where the measurement report is received by the NE without the notification of the configuration change.

The addition or application of artificial intelligence (AI) and/or machine learning (ML) models have been shown to improve performance in network devices. For example, implementations of AI/ML models in the physical (PHY) layer of communication links may improve device performance. However, due to the data-driven nature of these AI/ML models, and given that a trained model may have limited generalization capability, an AI/ML model that is performing well at a particular instance may exhibit a degraded, lower performance at another time. Accordingly, monitoring the performance of AI/ML models is an implementation task as part of the overall AI/ML LCM.

A procedure for monitoring the performance of an AI/ML model may depend on providing some measurement information that is only transmitted for the purpose of the monitoring. In an example, a UE may implement an AI/ML BM model that determines or predicts a best transmission and/or reception beam from a set of possible beams by performing measurements over a set of beam directions. A determined or predicted best beam, as determined by an AI/ML BM model, can then be subsequently transmitted to an NE (e.g., a gNB). To monitor the performance of this AI/ML BM model, the NE may configure the UE to perform measurements on the set of possible beams and communicate that information to the NE. The NE can then monitor the performance of the AI/ML BM model that is implemented at the UE to determine the best possible beams.

In this example, the UE can perform the measurements and communicate the measurement information to the NE for monitoring the model performance. Taking into account signaling overhead considerations that may be incurred by the additional measurements and information communication, the NE may configure the UE for a lesser frequency of measuring and reporting in an effort to reduce and/or minimize impacts on signaling overhead. Although a higher frequency of the measuring and reporting may provide a more accurate representation of the performance of the AI/ML BM model, the higher frequency would likely contribute to the increased overhead considerations. Aspects of the present disclosure are described in the context of a wireless communications system, and address AI/ML model performance monitoring and accuracy, while also maintaining the signaling overhead considerations within an acceptable operation range.

In another example, a network device or node, such as a UE, may implement an AI/ML model that generates and/or predicts information pertaining to a particular operation metric, or metrics. For example, an AI/ML model may be used to predict the probability of a RLF, which the UE is likely configured to communicate to the NE. To transmit, send, or otherwise communicate this information, the NE may have configured the UE to send the information periodically, with a certain periodicity. Alternatively, the UE may be implemented to request permission to send the predicted information, such as if a predicted RLF value is higher than a threshold and the UE schedules with the NE for reporting the information. This example may come with an undesirably high signaling overhead if the predicted RLF probability is reported too often, or may come with less overhead using less frequent reporting, yet with a higher chance of not detecting or missing the RLF. Accordingly, aspects of this disclosure are directed to implementations that balance AI/ML model measuring and reporting between exceeding signaling overhead expectations, yet maintaining detection accuracy.

In some measurement and reporting configurations, a UE may implement different conventional approaches for reporting measurement information to a NE (e.g., a gNB), such as periodic reporting, aperiodic reporting, and/or semi-persistent reporting. For periodic reporting, an NE may configure a UE to periodically report a metric (e.g., measurement information) with a certain period or frequency. With periodic reporting, the UE can provide regular updates of the measurement information, which may facilitate overhead load balancing and network operational efficiency. For aperiodic reporting, the NE may send a query message to the UE whenever it wants the UE to communicate the measurement information back to the NE. The aperiodic reporting may be used to provide more immediate information as to an aspect of an AI/ML model, and may be triggered by a more specific measurement event. For semi-persistent reporting, the NE may preconfigure one or more reporting configurations (for example, different configurations with different periodicities), and then activate or deactivate specific configurations whenever the NE wants a particular setting by communicating a message that requests the UE to start or stop sending messages to the NE based on one of the preconfigured reporting configurations.

With reference to information reporting, CSI reporting is implemented in a wireless communications system (e.g., for 5G communications) and allows for a UE to provide information about communication channel conditions to the network (e.g., to an NE, base station, gNB). This reported information may be used for optimizing link performance, including adaptive modulation and coding, link adaptation, and beamforming. A UE can measure and report CSI measurements of reference signals (CSI-RS) configured by the network, by using the CSI measurement and reporting framework. The network configures the UE with a CSI reporting configuration (CSI-ReportConfig) which includes the type and format of the CSI feedback and periodicity of the reporting. The CSI reporting configuration IE is used to configure different parameters for CSI reporting by the UE and associates a CSI resource configuration (CSI ResourceConfig) to be used by the UE for performing the measurements. A report quantity (reportQuantity) indicates the parameters that the UE is indicated to measure, such as CSI-related and layer 1 (L1)-reference signal received power (RSRP)-related quantities.

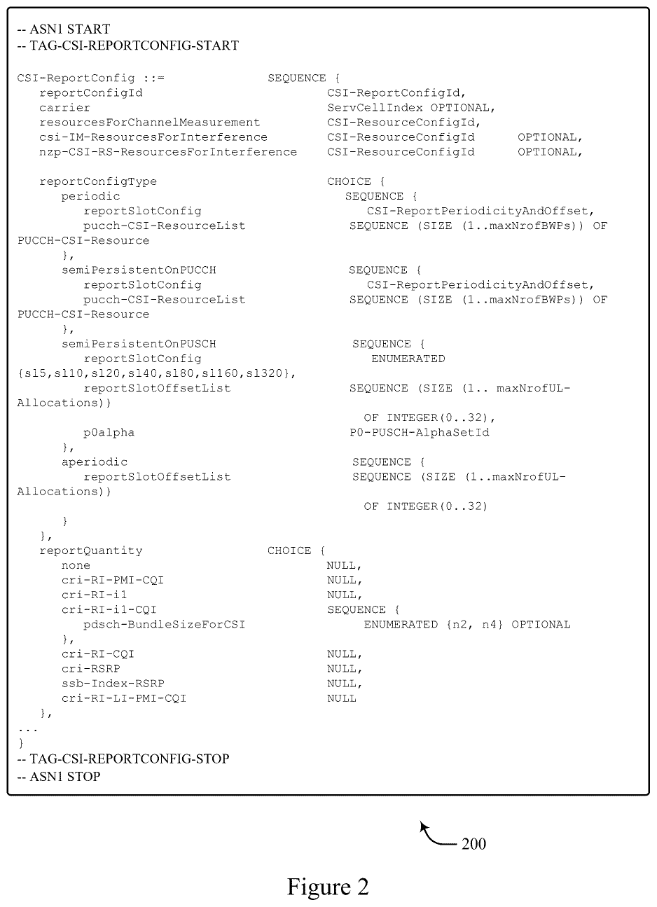

FIG. 2 illustrates an example IE CSI report configuration 200 (CSI-ReportConfig), in accordance with aspects of the present disclosure. The IE CSI report configuration 200 can be used to configure a periodic or semi-persistent report sent on a physical uplink control channel (PUCCH) on the network cell in which the CSI report configuration is included, or to configure a semi-persistent or aperiodic report sent on a physical uplink shared channel (PUSCH) that is triggered by downlink control information (DCI) received on the network cell in which the CSI report configuration is included. In this instance, the network cell on which the report is communicated is determined by the received DCI.

In this example, the CSI report configuration 200 includes various measurement resources and report quantities. The measurement resources include CSI reference signal (CSI-RS) resources that the NE (e.g., gNB) configures and the UE uses for channel measurements. The measurement resources also include synchronization signal block (SSB) resources, and the measurements can be based on SSBs, which are useful for beam management and initial access procedures.

With reference to the various report quantities, the CSI report configuration 200 specifies not only the periodicity of the reporting (i.e., as periodic, aperiodic, or semi-persistent), but also defines a format and the content of the CSI reports that the UE is expected to communicate to the NE. The report quantities include aspects of a component resource indicator (CRI), which indicates a preferred beam or CSI-RS resource. A rank indicator (RI) indicates a number of spatial layers. A precoding matrix indicator (PMI) recommends the precoding matrix. A channel quality indicator (CQI) indicates a modulation and coding scheme. The RSRP is a measure of the power of received signals. A synchronization signal block (SSB) index indicates which SSB is preferred for use. A layer indicator (LI) indicates mapping between codeword(s) and layer(s) in multi-layer transmission. Another aspect is i1, which is a part of the Type II codebook, representing wideband or subband spatial information. The report types in the CSI report configuration 200 include cri-RI-PMI-CQI, cri-RI-i1, cri-RI-i1-CQI, cri-RI-CQI, cri-RSRP, ssb-Index-RSRP, and cri-RI-LI-PMI-CQI.

With reference to RLF reporting, RLF refers to a situation where a UE experiences a loss of connection with the network. This can occur due to various reasons, such as poor signal quality, interference, or mobility-related issues. The RLF report contains detailed information about the latest connection failure experienced by the UE, which can be either a RLF or a handover failure (HOF). A RLF report provides for network optimization and troubleshooting. The RLF report is collected by the operations, administration, and maintenance (OAM) system and can be retrieved by an evolved NodeB (eNB) or next-generation NodeB (gNB).

A RLF report includes various types of information, such as location information, measurement results, an indication of impact to multimedia telephony (MMTEL) calls, and consecutive failures. The location information (if available), includes detailed location data, such as latitude, longitude, altitude, velocity, uncertainty, confidence, and direction. The measurement results may include measurements from a wireless local area network (WLAN), Bluetooth, and/or new radio (NR) neighbor cells, if available. An indication of impact to MMTEL calls may be an indication from a UE as to whether a radio bearer with quality of service class identifier (QCI) 1 was established when a failure was detected. As to consecutive failures, the report can include information about the latest two consecutive failures, particularly in scenarios involving conditional handover (CHO) and dual active protocol stack (DAPS) handovers.

In aspects of RLF, the NE (e.g., gNB) configures a UE for recording RLF events and reporting them. A recording and reporting scheme includes a configuration for RLF recording, RLF event detection and reporting, a reporting mechanism, and the messages used for reporting. With reference to the configuration for RLF recording, the NE uses the radio resource control (RRC) reconfiguration message to configure the UE for recording RLF events. This message contains the parameters and configurations for the UE to detect and record RLF events. With reference to RLF event detection and reporting, once the UE is configured, the UE detects a RLF event and collects specific information related to the failure based on the configuration. The UE then reports the RLF event to the NE. The report contains detailed information about the connection failure, including radio measurement results, WLAN and Bluetooth measurement results, sensor information, detailed location information, and a random access channel (RACH) failure report, if applicable.

With reference to the reporting mechanism, the RLF reporting is activated as a special trace session, and job type indicates RLF reporting only. When the trace session is activated, the NE (e.g., gNB) starts collecting RLF reports from the UE. In implementations, if the UE successfully re-establishes the RRC connection at the source gNB, then the RLF reports are fetched by a source gNB. If the UE successfully re-establishes the RRC connection at a target gNB, then the RLF reports are fetched by a target gNB. If there is an Xn interface link between the target gNB and the source gNB, then the target gNB forwards the RLF report to the source gNB. However, if there is no Xn interface link, then the target gNB reports the RLF report. With reference to the messages used for reporting, the RLF report is typically included in a RRC reestablishment request (RRCReestablishmentRequest) message sent by the UE to the NE during the re-establishment procedure. In implementations, the gNB can retrieve the RLF report from the UE or receive it from the target gNB via the Xn RLF indication message if there is an Xn interface link.

Notably, the above procedure is are mainly for reporting of the measurement of some configured metric after a link failure occurs. Alternatively, the UE may report these measurements with some periodicity even before RLF. This information may help the network to determine the possibility of RLF and attempt to adjust to prevent RLF. In this instance, instead of reporting the measurement data directly to the NE, the UE may compute some metrics showing the possibility or probability of the RLF, and then report this metric to the NE. Aspects of this disclosure are directed, for the most part, to reporting the probability of RLF, or reporting the metrics related to RLF, before a link actually fails.

With reference to other considerations for managing the signaling overhead and performance tradeoff, one approach is to manage for a higher performance, such as for monitoring or for RLF prediction reporting, by increasing the frequency of reporting which comes with high signaling overhead. Alternatively, the NE (e.g., gNB) configures a UE with less frequent reporting, and then whenever the NE detects that more frequent reporting is needed, it can reconfigure the UE to perform more frequent reporting. Alternatively, using semi-persistent reporting, the NE can pre-configure low overhead and high overhead options, and switch between them based on the detected current need. This option resolves the signaling overhead issue to some extent. However, for some use cases, the gNB is not the best entity to determine if more frequent reporting is needed or not. For example, in the case of monitoring a AI/ML model implemented by a UE, the UE may have more local information to determine if the model is more vulnerable to current errors, in which case more frequent monitoring may be beneficial. For example, in a BM management use case, based on some UE conditions, such as velocity or a change of the input data statistics, the UE may detect that there is higher chance of model failure and thus more frequent monitoring may be needed. Additionally, for RLF and based on the UE measurements and other factors (UE velocity), the UE may attempt to send more frequent reporting as to the possibility of a RLF. The gNB controlled semi-persistent or periodic reporting may not be the best solution for these cases.

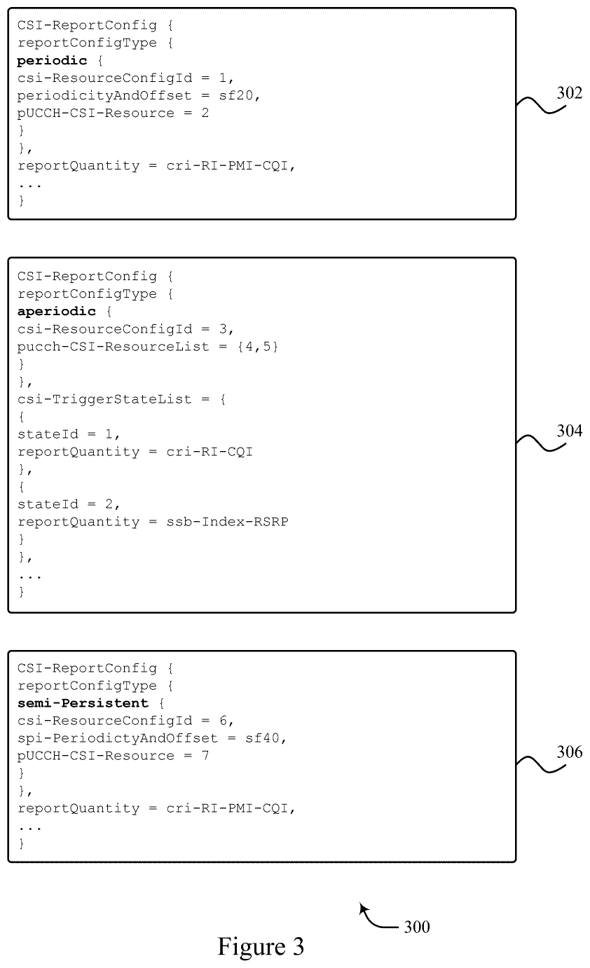

FIG. 3 illustrates an example IEs 300 for CSI-ReportConfig: periodic reporting, aperiodic reporting, and semi-persistent reporting, in accordance with aspects of the present disclosure. As discussed above, there are mainly three modes of CSI reporting for reporting measurement information to a NE (e.g., a gNB), including periodic reporting, aperiodic reporting, and/or semi-persistent reporting. In this example for periodic reporting 302, a UE can send CSI reports at regular, pre-defined intervals without any explicit prompting from the network after initial configuration. The NE (e.g., gNB) sets the reporting periodicity and offset with parameters in the CSI configuration report (CSI-ReportConfig). In this example for aperiodic reporting 304, the UE can report CSI based on an explicit request from the NE, as may be indicated via DCI messages. This allows the NE to request CSI reports from the UE on-demand, which is suitable when the network attains CSI feedback only under certain conditions. Further for aperiodic reporting 304, the NE triggers aperiodic CSI reports by sending a DCI message with a CSI request field over the PDCCH. To start transmission, a field (e.g., “CSI request field”) in the DCI message is set to one and can indicate which csi-TriggerState to use.

In this example for semi-persistent reporting 306, CSI is reported periodically in a hybrid approach, but can be adjusted based on network signaling. The NE (e.g., gNB) configures the UE to send CSI reports at pre-defined intervals, but these intervals can be activated or deactivated by the NE, allowing dynamic control over reporting without per-report triggering. Further for semi-persistent reporting 306, the NE can activate or deactivate the CSI reporting via medium access (MAC) control elements (CEs) (MAC CEs). This allows the network to control whether and which configuration the UE should use for current reporting, without reconfiguring via RRC messages. The semi-persistent reporting 306 provides timely CSI updates when activated. However, activation or deactivation via MAC CE introduces some control latency compared to report triggering in aperiodic reporting. Compared with aperiodic reporting, this latency with semi-persistent reporting is due to not requesting immediate CSI updates on demand because the MAC-CE based activation and deactivation commands have a slower response time compared to DCI-triggered reports.

Selection of a reporting mechanism or scenario can depend on various factors, such as the use case, the required accuracy, how much signaling overhead can be tolerated, and which entity (e.g., a UE or gNB) performs the monitoring task. In general, semi-persistent reporting can be used for cases in which different reporting periodicity is needed for different situations, but it has two main issues. The gNB might not have the complete and most up-to-date information to make the best informed decision on which configuration to select and use. Further, there is a latency in reporting a mode change associated with sending a change command from the gNB to the UE.

Aspects of the described techniques in this disclosure offer solutions to the drawbacks of the current modes of CSI reporting for reporting measurement information to a NE (e.g., a gNB), as well as to balance signaling overhead and latency. The described techniques include a first implementation that provides for requesting a change of the reporting (CSI reporting) method. A second implementation provides for a semi-autonomous change of the reporting (CSI reporting) method. A third implementation provides for a rule-based change of the reporting (CSI reporting) method. These solutions provide that a UE can determine whether a current state of the UE requires a different reporting configuration, and in particular, a different reporting periodicity. In one or more implementations, a UE reporting configuration can be updated to a new configuration that allows the UE to communicate a request for the new configuration that has a different reporting periodicity, or for selection of a different reporting configuration (e.g., in the case of semi-persistent reporting). A UE reporting configuration may be updated to a new configuration that allows for UE reporting of another metric along with a measurement that indicates an estimated validity or confidence of the reported data. New reporting configurations may also be implemented that enable a semi-autonomous change of the reporting configurations and/or a rule-based reporting configuration modification.

In implementations that provide for requesting a change of the reporting (CSI reporting) method, a UE can determine that a current reporting configuration (e.g., reporting periodicity) is not adequate, and communicate a request to the NE (e.g., gNB) requesting a new or updated reporting (CSI-reporting) configuration. The UE can also communicate to the NE the requested parameters, such as the requested periodicity. In another implementation, for example when the UE uses semi-persistent reporting, the UE may indicate or suggest the other configurations that are pre-configured but not currently active. Notably, the measurement configuration can remain unchanged and the UE may not initiate a request for a change of the measurement configuration (e.g., no change is needed for the gNB transmitting the reference signals (RSs)). The UE, however, may request to only change the reporting configurations, such as to request a change in the periodicity, or a change in the active configuration in the semi-persistent reporting mode.

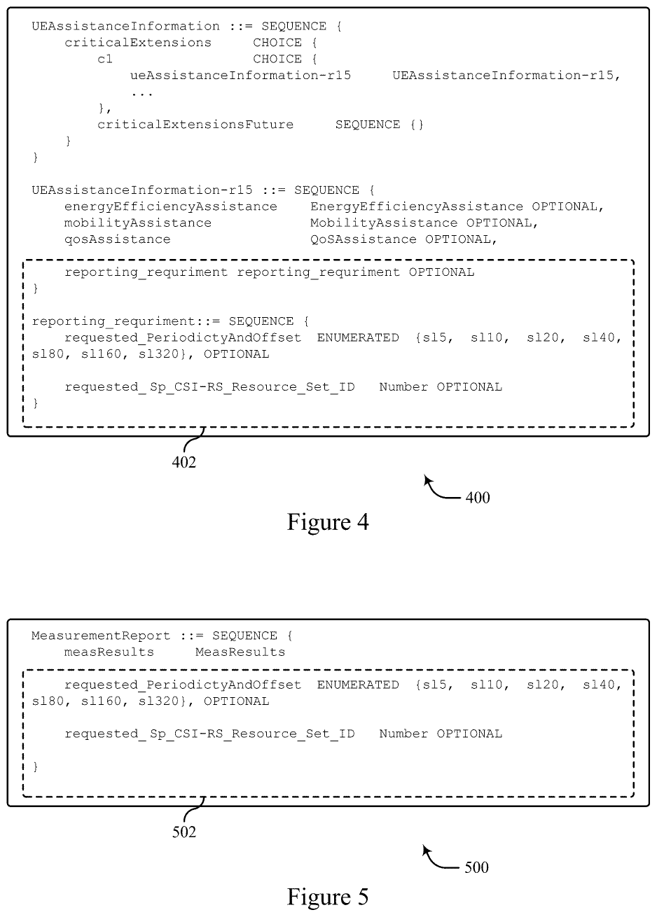

Additionally, in some implementation, a UE may be allowed to send requests for a change of the measurement configuration to the NE (e.g., in the network) if the network first configured and allowed the UE to initiate such requests. In some instances, an initial configuration of the measurement and information reporting, the network notifies the UE using, for example, a specific type of CSI report configuration (CSI-ReportConfig), a new type of report configuration (reportConfigType), or a new IE (e.g., in CSI-ReportConfig, or reportConfigType) that for a particular configuration, the UE can request for a modification of the reporting configuration. This reporting information can be communicated by a UE using new information inside messages, such as a UE assistance information (UEAssistanceInformation) message (FIG. 4), or as a measurement report (MeasurementReport) (FIG. 5) if the UE is already communicating, sending, or providing some CSI-reporting.

FIG. 4 illustrates an example information report 400, in accordance with aspects of the present disclosure. In this example information report 400, the UE assistance information (UEAssistanceInformation) can include additional fields 402 that indicate a requested change in periodicity and/or offset.

FIG. 5 illustrates an example measurement report 500, in accordance with aspects of the present disclosure. In this example, the measurement report 500 can include additional fields 502 that indicate requested reporting of the change in periodicity and/or offset. In one or more implementations, apart from the requested configuration change, the UE may communicate information that requests the change of the reporting configurations after T₁ time unit, or at most after T₁ time units. In some implementations, the UE may communicate additional information that requests the change of the configuration for a certain period (i.e., T₂ time units). In this instance, after T₂ time units, the requested configuration is no longer valid and the UE and network (e.g., NE, gNB) can switch back to the current or default settings. For example, while monitoring an AI/ML model implemented at a UE, the UE can determine that the model is not currently stable, and initiate a request for additional, more frequent monitoring, while the UE is also configured so that the current disturbance will be completed or finished at most after T₂ time units. The UE can therefore initiate a request for the higher monitoring frequency (e.g., a higher report frequency), but only for the T₂ time units.

In another implementation, instead of or along with a request for a change in the reporting configuration, a UE may communicate another IE to the NE (e.g., gNB) capturing the validity (e.g., T₀ time units) of the reported metric, or when the UE determines that the reported data might change (e.g., in T₁ time units). The NE then can use this information to change the reporting configuration. Alternatively, if the UE detects that the predicted outcome may not change, it can also indicate this information using the time units (Tₙ) measure and if configured by the NE, the UE may skip the next reporting instances until time Tₙ. For example, along with sending monitoring information, the UE can communicate additional information associated with an expectation as to how long the current monitoring result will be valid. For example, if the UE is operational with high speed, or the statistics of the input data changes, the UE can report a low validity time frame, which the NE can use to reduce the reporting interval.

In another example, the UE may predict a RLF and communicate the information that the UE expects the current reported RLF may change in a short amount of time (low validity time frame for the reported metric). This information may help the NE (e.g., gNB) determine a better reporting configuration. In another example, the UE can communicate information about the RLF validity indicating that the RLF prediction is valid for a longer time frame, which is larger than the next reporting interval. In another implementation, instead of or along with the request for a change of the reporting configuration, the UE may communicate another IE to the NE that indicates a confidence of the reported metric. For example, the UE communicates that the probability of RLF is low (e.g., 0.001), but the UE also knows or detects that this number is not that accurate (e.g., due to the high speed of the UE), so the UE reports a low confidence on this metric. The NE then can use this information to change the reporting configuration. Additionally, the NE can also use this information to determine the validity of the predicted outcome, and the information may be discarded.

In implementations that provide for a semi-autonomous change of the reporting (CSI reporting) method, an NE (e.g., gNB) can configure multiple reporting (CSI-Reporting) settings. A main difference from the conventional semi-persistent reporting is that in this semi-autonomous change of the reporting method, all of the reporting schemes are pre-approved by the NE. Accordingly, if the a UE indicates to the NE that it wants to switch to a particular setting, the UE can assume that the NE will accept the request after T₁ time units and the UE does not need to wait for the NE to activate or deactivate the update switch to the particular setting in a separate message. To ensure that the UE and the NE (e.g., gNB) remain consistent in the reporting configuration, although the UE can assume that the NE will fulfil its request, the UE can still confirm that the NE has received its change request message. In an example implementation, such as for a UE assistance information (UEAssistanceInformation) message, the UE may use the HARQ feedback for the RRC message, and new data indicator (NDI) is toggled for the HARQ process for a RRC message that was transmitted. Receiving this confirmation, the UE may apply the new configuration after T₁ time units. This provides a small bit of time for the NE to adjust to the configuration change that has been requested by the UE and before the new reporting method takes effect.

In an example implementation, and if a UE is already configured with a first setting “I” for low frequency of report and a second setting “II” for higher frequency of sending a report, and then the UE determines that the report (CSI-report) second setting is the better option or setting for the current condition (for example it has high velocity), then the UE can communicate a message (e.g., “Selected_CSI_config_change=II” to the NE (e.g., gNB) and wait for T₁ seconds, making sure that the NE has accommodated the request and then start reporting based on the updated second configuration. The Selected_CSI_config_change can be sent as a part of the UE assistance information (UEAssistanceInformation) or if the UE is already reporting the CSI, it can be sent as another field of the report (e.g., as another field in the measurement report (MeasurementReport)). In an implementation, the UE will wait until the NE provides a confirmation of enabling the new report setting.

In implementations that provide for a rule-based change of the reporting (CSI-reporting) method, and along with the configuration of multiple reporting settings (similar to the semi-persistent method), the NE (e.g., gNB) can communicate some rules for switching between different pre-configured configurations. The UE and NE can then follow the same rule for determining which reporting configuration should be used. For example, in a scenario of monitoring an AI/ML model, there may be multiple thresholds, and if the model performance at a particular time slot (and at this report) is larger than Th₁, then continue using the same report configuration. However, if the model performance is lower than Th₁ and larger than Th₂ using the second report configuration (e.g., for a higher frequency of reporting) for the next report or from the report after T₁ (giving enough time for the NE to switch to the new settings), and if the performance is lower than Th₂, then use the last CSI configuration settings.

Note that in this approach, there is no need for an implicit request or indication from the UE for switching between the CSI configurations, due to the UE and NE (e.g., gNB) operating based on the same rule (e.g., based on comparing the current report with a set of thresholds, in the above example). This will eliminate the signaling latency that may occur in a conventional semi-persistent reporting method. In this case, as the UE and the NE should make a determination based on a certain metric (e.g., model performance as in the previous example), to make sure of the consistency between the UE and the NE configuration assumptions.
Assuming that the UE and the NE (e.g., gNB) are now using a configuration A, in an implementation and based on the rule and the current metric value, the UE can determine that for the “next” configuration settings, switch to configuration B. The UE then communicates the metric to the network (e.g., NE, gNB) after T₁ time units based on the current configuration A. The UE can then check as to whether the transmitted metric has been successfully delivered to the gNB, for example using the acknowledgement (ACK) message or HARQ feedback. The UE may then wait for another T₂ time units for the processing and configuration switching time needed at the network side, and after the delay, the UE can consider that the new configuration is active and consistent between devices.

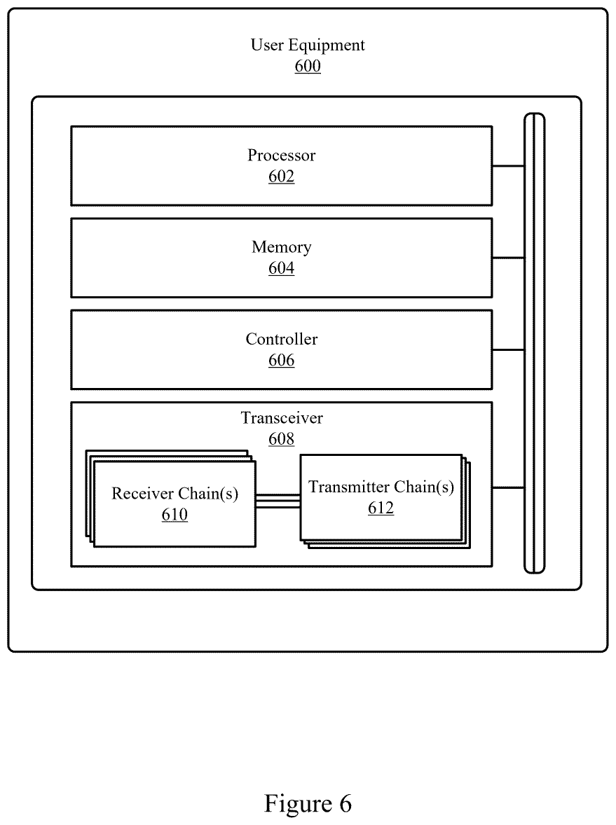

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. For example, the UE may be configured to, capable of, or operable to receive, from a NE, configuration information for at least one of measurement or reporting, where the configuration information indicates whether the UE is allowed to request an update for one or more parameters associated with at least one of the measurement or reporting; and transmit, to the NE, an update request to change the one or more parameters associated with at least one of the measurement or reporting.

A method performed or performable by the UE 600 for wireless communication is described. The method may include receiving, from a NE, configuration information for at least one of measurement or reporting, where the configuration information indicates whether the UE is allowed to request an update for one or more parameters associated with at least one of the measurement or reporting; and transmitting, to the NE, an update request to change the one or more parameters associated with at least one of the measurement or reporting.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. For example, the UE may be configured to, capable of, or operable to receive, from a NE, configuration information for at least one of measurement or reporting, where the configuration information indicates whether the UE is allowed to initiate an update for one or more parameters associated with at least one of the measurement or reporting; and transmit, to the NE, at least one of an update notification to change the one or more parameters associated with at least one of the measurement or reporting, or a selection of a pre-configured configuration from a set of pre-configured configurations.

A method performed or performable by the UE 600 for wireless communication is described. The method may include receiving, from a NE, configuration information for at least one of measurement or reporting, where the configuration information indicates whether the UE is allowed to initiate an update for one or more parameters associated with at least one of the measurement or reporting; and transmitting, to the NE, at least one of an update notification to change the one or more parameters associated with at least one of the measurement or reporting, or a selection of a pre-configured configuration from a set of pre-configured configurations.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. For example, the UE may be configured to, capable of, or operable to receive, from a NE, configuration information for at least one of measurement or reporting, where the configuration information indicates whether the UE is allowed to initiate an update for one or more parameters associated with at least one of the measurement or reporting, or select a pre-configured configuration from a set of pre-configured configurations; perform measurements based at least in part on the update and without notifying the NE of the update; and transmit, to the NE, a measurement report of measurement results, where the measurement report is transmitted without notifying the NE of the update.

A method performed or performable by the UE 600 for wireless communication is described. The method may include receiving, from a NE, configuration information for at least one of measurement or reporting, where the configuration information indicates whether the UE is allowed to initiate an update for one or more parameters associated with at least one of the measurement or reporting, or select a pre-configured configuration from a set of pre-configured configurations; performing measurements based at least in part on the update and without notifying the NE of the update; and transmitting, to the NE, a measurement report of measurement results, where the measurement report is transmitted without notifying the NE of the update.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving, from a NE, configuration information that includes measurement parameters and reporting instructions, the configuration information indicating that the UE is allowed to request a configuration change; and transmitting, to the NE, the request for the configuration change that indicates a request to change at least one of the reporting instructions or the measurement parameters.

Additionally, the UE 600 may be configured to support any one or combination of the method including receiving, from the NE, updated configuration information based at least in part on the request for the configuration change, the updated configuration information including at least one of updated reporting instructions or updated measurement parameters. The method including selecting a pre-configured configuration from a set of pre-configured configurations; and transmitting the request for the configuration change associated with the selected pre-configured configuration. The method including selecting the pre-configured configuration from the set of pre-configured configurations based at least in part on current measured parameter results; and transmitting the request for the configuration change indicating the selected pre-configured configuration. The request for the configuration change indicates a change in periodicity of reporting measured parameter results. The method including transmitting, to the NE, a measurement report that includes measured parameter results and a validity period associated with the measured parameter results, where the validity period is a time duration after which the UE expects a change in reported measured parameter results. The method including transmitting, to the NE, a measurement report that includes measured parameter results and a confidence value that indicates a likelihood of change of subsequent measured parameter results.

Additionally, or alternatively, the UE 600 may support at least one memory (e.g., the memory 604) and at least one processor (e.g., the processor 602) coupled with the at least one memory and configured to cause the UE to receive, from a NE, configuration information that includes measurement parameters and reporting instructions, the configuration information indicating that the UE is allowed to request a configuration change; and transmit, to the NE, the request for the configuration change that indicates a request to change at least one of the reporting instructions or the measurement parameters.

Additionally, the UE 600 may be configured to support any one or combination of the at least one processor is operable to cause the UE to receive, from the NE, updated configuration information based at least in part on the request for the configuration change, the updated configuration information including at least one of updated reporting instructions or updated measurement parameters. The UE has a set of pre-configured configurations; and the at least one processor is operable to cause the UE to select a pre-configured configuration from the set of pre-configured configurations; and transmit the request for the configuration change associated with the selected pre-configured configuration. The at least one processor is operable to cause the UE to select the pre-configured configuration from the set of pre-configured configurations based at least in part on current measured parameter results; and transmit the request for the configuration change indicating the selected pre-configured configuration. The request for the configuration change indicates a change in periodicity of reporting measured parameter results. The at least one processor is operable to cause the UE to transmit, to the NE, a measurement report that includes measured parameter results and a validity period associated with the measured parameter results, where the validity period is a time duration after which the UE expects a change in reported measured parameter results. The at least one processor is operable to cause the UE to transmit, to the NE, a measurement report that includes measured parameter results and a confidence value that indicates a likelihood of change of subsequent measured parameter results.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving, from a NE, configuration information that includes measurement parameters and reporting instructions, the configuration information indicating that the UE is allowed to initiate a configuration change; and transmitting, to the NE, a notification of the configuration change that indicates at least one of a change of the reporting instructions, a change of the measurement parameters, or a selection of a pre-configured configuration from a set of pre-configured configurations.

Additionally, the UE 600 may be configured to support any one or combination of the method including selecting the pre-configured configuration from the set of pre-configured configurations based at least in part on current measured parameter results. The configuration information includes a timing delay; and the method including transmitting, to the NE, the notification of the configuration change, and wait a time duration of the timing delay before at least one of continuing parameter measurements or reporting measured parameter results based at least in part on the configuration change. The method including starting a timer to wait the timing delay, where the timer is started based at least in part on a confirmation that the NE received the notification of the configuration change. The method including receiving HARQ feedback as the confirmation that the NE received the notification of the configuration change.

Additionally, or alternatively, the UE 600 may support at least one memory (e.g., the memory 604) and at least one processor (e.g., the processor 602) coupled with the at least one memory and configured to cause the UE to receive, from a NE, configuration information that includes measurement parameters and reporting instructions, the configuration information indicating that the UE is allowed to initiate a configuration change; and transmit, to the NE, a notification of the configuration change that indicates at least one of a change of the reporting instructions, a change of the measurement parameters, or a selection of a pre-configured configuration from a set of pre-configured configurations.

Additionally, the UE 600 may be configured to support any one or combination of the at least one processor is operable to cause the UE to select the pre-configured configuration from the set of pre-configured configurations based at least in part on current measured parameter results. The configuration information includes a timing delay; the at least one processor is operable to cause the UE to transmit, to the NE, the notification of the configuration change, and wait a time duration of the timing delay before at least one of continuing parameter measurements or reporting measured parameter results based at least in part on the configuration change. The at least one processor is operable to cause the UE to start a timer to wait the timing delay, where the timer is started based at least in part on a confirmation that the NE received the notification of the configuration change. The at least one processor is operable to cause the UE to receive HARQ feedback as the confirmation that the NE received the notification of the configuration change.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving, from a NE, configuration information that includes measurement parameters and reporting instructions, the configuration information indicating that the UE is allowed to initiate a configuration change of at least one of the reporting instructions, the measurement parameters, or a selection of a pre-configured configuration from a set of pre-configured configurations; performing parameter measurements based at least in part on the configuration change and without notifying the NE of the configuration change; and transmitting, to the NE, a measurement report that includes measured parameter results, where the measurement report is transmitted without notifying the NE of the configuration change.

Additionally, the UE 600 may be configured to support any one or combination of the configuration information includes a set of configuration rules by which the UE and the NE initiate the configuration change. The configuration information includes a timing delay, and the method including performing the parameter measurements based at least in part on the configuration information before the configuration change; and transmitting, to the NE, an initial measurement report, and wait a time duration of the timing delay before at least one of continuing parameter measurements or reporting measured parameter results based at least in part on the configuration change. The method including starting a timer to wait the timing delay, where the timer is started based at least in part on a confirmation that the NE received the initial measurement report. The method including receiving HARQ feedback as the confirmation that the NE received the initial measurement report.

Additionally, or alternatively, the UE 600 may support at least one memory (e.g., the memory 604) and at least one processor (e.g., the processor 602) coupled with the at least one memory and configured to cause the UE to receive, from a NE, configuration information that includes measurement parameters and reporting instructions, the configuration information indicating that the UE is allowed to initiate a configuration change of at least one of the reporting instructions, the measurement parameters, or a selection of a pre-configured configuration from a set of pre-configured configurations; perform parameter measurements based at least in part on the configuration change and without notifying the NE of the configuration change; and transmit, to the NE, a measurement report that includes measured parameter results, where the measurement report is transmitted without notifying the NE of the configuration change.

Additionally, the UE 600 may be configured to support any one or combination of the configuration information includes a set of configuration rules by which the UE and the NE initiate the configuration change. The configuration information includes a timing delay and the at least one processor is operable to cause the UE to perform the parameter measurements based at least in part on the configuration information before the configuration change; and transmit, to the NE, an initial measurement report, and wait a time duration of the timing delay before at least one of continuing parameter measurements or reporting measured parameter results based at least in part on the configuration change. The at least one processor is operable to cause the UE to start a timer to wait the timing delay, where the timer is started based at least in part on a confirmation that the NE received the initial measurement report. The at least one processor is operable to cause the UE to receive HARQ feedback as the confirmation that the NE received the initial measurement report.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

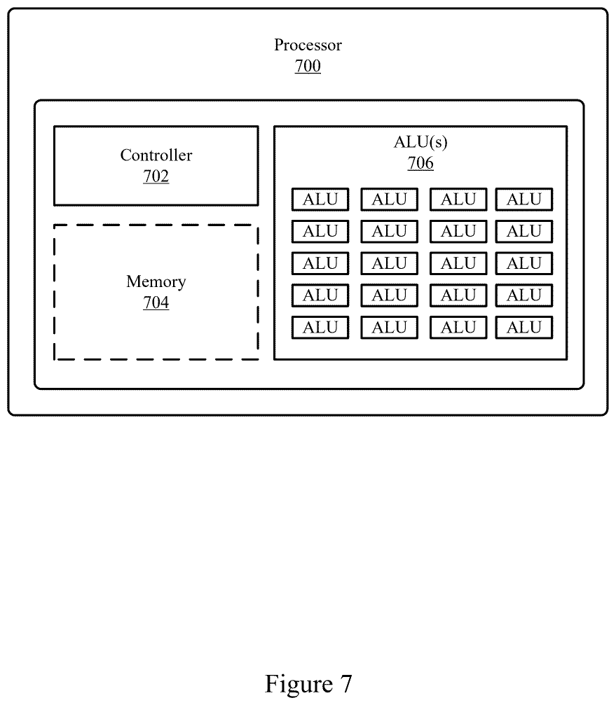

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive, from a NE, configuration information for at least one of measurement or reporting, where the configuration information indicates whether a UE is allowed to request an update for one or more parameters associated with at least one of the measurement or reporting; and transmit, to the NE, an update request to change the one or more parameters associated with at least one of the measurement or reporting.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive, from a NE, configuration information for at least one of measurement or reporting, where the configuration information indicates whether a UE is allowed to initiate an update for one or more parameters associated with at least one of the measurement or reporting; and transmit, to the NE, at least one of an update notification to change the one or more parameters associated with at least one of the measurement or reporting, or a selection of a pre-configured configuration from a set of pre-configured configurations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive, from a NE, configuration information for at least one of measurement or reporting, where the configuration information indicates whether a UE is allowed to initiate an update for one or more parameters associated with at least one of the measurement or reporting, or select a pre-configured configuration from a set of pre-configured configurations; perform measurements based at least in part on the update and without notifying the NE of the update; and transmit, to the NE, a measurement report of measurement results, where the measurement report is transmitted without notifying the NE of the update.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to transmit, to a UE, configuration information for one or more of at least one of measurement or reporting, a set of pre-configured configurations, or a set of configuration rules, where the configuration information indicates whether the UE is allowed to at least one of request an update for one or more parameters associated with at least one of the measurement or reporting, or initiate the update; and one of: for a requested update, receive from the UE, an update request to change the one or more parameters associated with at least one of the measurement or reporting; for a notified update, receive from the UE, an update notification to change the one or more parameters associated with at least one of the measurement or reporting, or an update of measurement results; or for an initiated update, receive from the UE, a measurement report of measurement results, where the measurement report is received without notification of the initiated update.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive, from a NE, configuration information that includes measurement parameters and reporting instructions, the configuration information indicating that a UE is allowed to request a configuration change; and transmit, to the NE, the request for the configuration change that indicates a request to change at least one of the reporting instructions or the measurement parameters.

Additionally, the processor 700 may be configured to or operable to support any one or combination of the at least one controller is operable to cause the processor to receive, from the NE, updated configuration information based at least in part on the request for the configuration change, the updated configuration information including at least one of updated reporting instructions or updated measurement parameters. The at least one controller is operable to cause the processor to select a pre-configured configuration from a set of pre-configured configurations; and transmit the request for the configuration change associated with the selected pre-configured configuration. The at least one controller is operable to cause the processor to select the pre-configured configuration from the set of pre-configured configurations based at least in part on current measured parameter results; and transmit the request for the configuration change indicating the selected pre-configured configuration. The request for the configuration change indicates a change in periodicity of reporting measured parameter results. The at least one controller is operable to cause the processor to transmit, to the NE, a measurement report that includes measured parameter results and a validity period associated with the measured parameter results, where the validity period is a time duration after which the UE expects a change in reported measured parameter results. The at least one controller is operable to cause the processor to transmit, to the NE, a measurement report that includes measured parameter results and a confidence value that indicates a likelihood of change of subsequent measured parameter results.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive, from a NE, configuration information that includes measurement parameters and reporting instructions, the configuration information indicating that a UE is allowed to initiate a configuration change; and transmit, to the NE, a notification of the configuration change that indicates at least one of a change of the reporting instructions, a change of the measurement parameters, or a selection of a pre-configured configuration from a set of pre-configured configurations.

Additionally, the processor 700 may be configured to or operable to support any one or combination of the at least one controller is operable to cause the processor to select the pre-configured configuration from the set of pre-configured configurations based at least in part on current measured parameter results. The configuration information includes a timing delay; and the at least one controller is operable to cause the processor to transmit, to the NE, the notification of the configuration change, and wait a time duration of the timing delay before at least one of continuing parameter measurements or reporting measured parameter results based at least in part on the configuration change. The at least one controller is operable to cause the processor to start a timer to wait the timing delay, where the timer is started based at least in part on a confirmation that the NE received the notification of the configuration change. The at least one controller is operable to cause the processor to receive HARQ feedback as the confirmation that the NE received the notification of the configuration change.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive, from a NE, configuration information that includes measurement parameters and reporting instructions, the configuration information indicating that a UE is allowed to initiate a configuration change of at least one of the reporting instructions, the measurement parameters, or a selection of a pre-configured configuration from a set of pre-configured configurations; perform parameter measurements based at least in part on the configuration change and without notifying the NE of the configuration change; and transmit, to the NE, a measurement report that includes measured parameter results, where the measurement report is transmitted without notifying the NE of the configuration change.

Additionally, the processor 700 may be configured to or operable to support any one or combination of configuration information includes a set of configuration rules by which the UE and the NE initiate the configuration change. The configuration information includes a timing delay; the at least one controller is operable to cause the processor to perform the parameter measurements based at least in part on the configuration information before the configuration change; and transmit, to the NE, an initial measurement report, and wait a time duration of the timing delay before at least one of continuing parameter measurements or reporting measured parameter results based at least in part on the configuration change. The at least one controller is operable to cause the processor to start a timer to wait the timing delay, where the timer is started based at least in part on a confirmation that the NE received the initial measurement report. The at least one controller is operable to cause the processor to receive HARQ feedback as the confirmation that the NE received the initial measurement report.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to transmit, to a UE, configuration information that includes one or more of measurement parameters, reporting instructions, a set of pre-configured configurations, or a set of configuration rules, where the configuration information indicates that the UE is allowed to at least one of request a configuration change or initiate the configuration change; and one of: for a requested configuration change, receive from the UE, the request for the configuration change that indicates a request to change at least one of the reporting instructions or the measurement parameters; for a notified configuration change, receive from the UE, a notification of the configuration change that indicates at least one of the change of the reporting instructions or the change of the measurement parameters; or for an initiated configuration change, receive from the UE, a measurement report that includes measured parameter results, where the measurement report is received without the notification of the configuration change.

Additionally, the processor 700 may be configured to or operable to support any one or combination of the request for the configuration change or the notification of the configuration change includes an indication that the UE selected a pre-configured configuration from the set of pre-configured configurations. The at least one controller is operable to cause the processor to determine, based at least in part on the measurement report and the set of configuration rules, that the UE changed at least one of the reporting instructions, the measurement parameters, or selected a different pre-configured configuration from the set of pre-configured configurations.

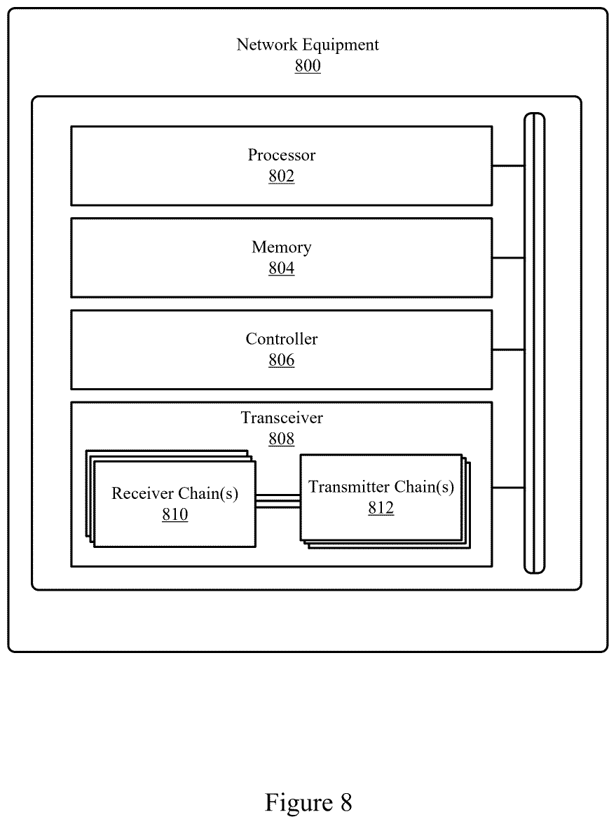

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. For example, the NE may be configured to, capable of, or operable to transmit, to a UE, configuration information for one or more of at least one of measurement or reporting, a set of pre-configured configurations, or a set of configuration rules, where the configuration information indicates whether the UE is allowed to at least one of request an update for one or more parameters associated with at least one of the measurement or reporting, or initiate the update; and one of: for a requested update, receive from the UE, an update request to change the one or more parameters associated with at least one of the measurement or reporting; for a notified update, receive from the UE, an update notification to change the one or more parameters associated with at least one of the measurement or reporting, or an update of measurement results; or for an initiated update, receive from the UE, a measurement report of measurement results, where the measurement report is received by the NE without notification of the initiated update.

A method performed or performable by the NE 800 (e.g., a base station, gNB) for wireless communication is described. The method may include transmitting, to a UE, configuration information for one or more of at least one of measurement or reporting, a set of pre-configured configurations, or a set of configuration rules, where the configuration information indicates whether the UE is allowed to at least one of request an update for one or more parameters associated with at least one of the measurement or reporting, or initiate the update; and one of: for a requested update, receiving from the UE, an update request to change the one or more parameters associated with at least one of the measurement or reporting; for a notified update, receiving from the UE, an update notification to change the one or more parameters associated with at least one of the measurement or reporting, or an update of measurement results; or for an initiated update, receiving from the UE, a measurement report of measurement results, where the measurement report is received by the NE without notification of the initiated update.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting, to a UE, configuration information that includes one or more of measurement parameters, reporting instructions, a set of pre-configured configurations, or a set of configuration rules, where the configuration information indicates that the UE is allowed to at least one of request a configuration change or initiate the configuration change; and one of: for a requested configuration change, receiving from the UE, the request for the configuration change that indicates a request to change at least one of the reporting instructions or the measurement parameters; for a notified configuration change, receiving from the UE, a notification of the configuration change that indicates at least one of the change of the reporting instructions or the change of the measurement parameters; or for an initiated configuration change, receiving from the UE, a measurement report that includes measured parameter results, where the measurement report is received by the NE without the notification of the configuration change.

Additionally, the NE 800 may be configured to or operable to support any one or combination of the request for the configuration change or the notification of the configuration change includes an indication that the UE selected a pre-configured configuration from the set of pre-configured configurations. The method including determining, based at least in part on the measurement report and the set of configuration rules, that the UE changed at least one of the reporting instructions, the measurement parameters, or selected a different pre-configured configuration from the set of pre-configured configurations.

Additionally, or alternatively, the NE 800 may support at least one memory (e.g., the memory 804) and at least one processor (e.g., the processor 802) coupled with the at least one memory and configured to cause the NE to transmit, to a UE, configuration information that includes one or more of measurement parameters, reporting instructions, a set of pre-configured configurations, or a set of configuration rules, where the configuration information indicates that the UE is allowed to at least one of request a configuration change or initiate the configuration change; and one of: for a requested configuration change, receive from the UE, the request for the configuration change that indicates a request to change at least one of the reporting instructions or the measurement parameters; for a notified configuration change, receive from the UE, a notification of the configuration change that indicates at least one of the change of the reporting instructions or the change of the measurement parameters; or for an initiated configuration change, receive from the UE, a measurement report that includes measured parameter results, where the measurement report is received by the NE without the notification of the configuration change.

Additionally, the NE 800 may be configured to support any one or combination of the request for the configuration change or the notification of the configuration change includes an indication that the UE selected a pre-configured configuration from the set of pre-configured configurations. The at least one processor is operable to cause the NE to determine, based at least in part on the measurement report and the set of configuration rules, that the UE changed at least one of the reporting instructions, the measurement parameters, or selected a different pre-configured configuration from the set of pre-configured configurations.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

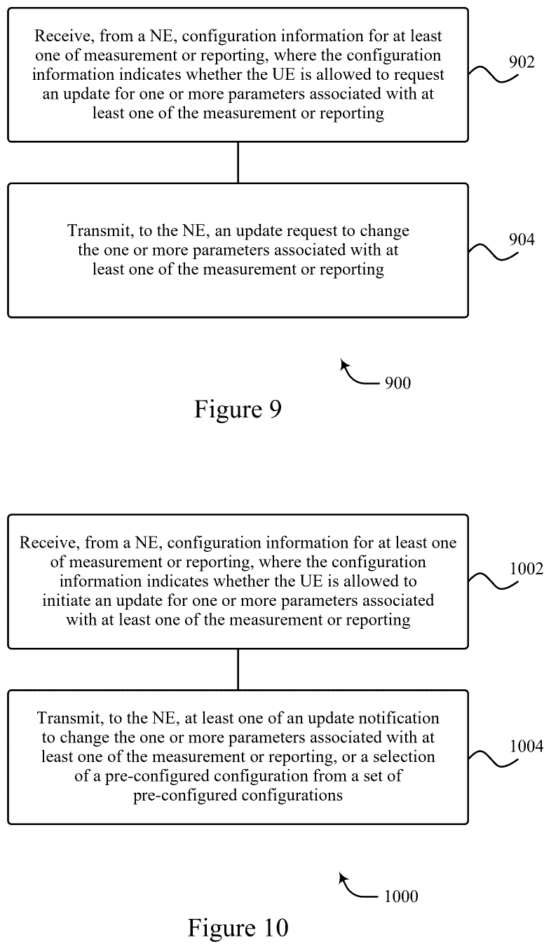

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving, from a NE, configuration information for at least one of measurement or reporting, where the configuration information indicates whether the UE is allowed to request an update for one or more parameters associated with at least one of the measurement or reporting. The operations of 902 may be performed in accordance with examples as described herein. In some implementations, aspects of the operations of 902 may be performed by a UE as described with reference to FIG. 6.

At 904, the method may include transmitting, to the NE, an update request to change the one or more parameters associated with at least one of the measurement or reporting. The operations of 904 may be performed in accordance with examples as described herein. In some implementations, aspects of the operations of 904 may be performed by a UE as described with reference to FIG. 6.

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving, from a NE, configuration information for at least one of measurement or reporting, where the configuration information indicates whether the UE is allowed to initiate an update for one or more parameters associated with at least one of the measurement or reporting. The operations of 1002 may be performed in accordance with examples as described herein. In some implementations, aspects of the operations of 1002 may be performed by a UE as described with reference to FIG. 6.

At 1004, the method may include transmitting, to the NE, at least one of an update notification to change the one or more parameters associated with at least one of the measurement or reporting, or a selection of a pre-configured configuration from a set of pre-configured configurations. The operations of 1004 may be performed in accordance with examples as described herein. In some implementations, aspects of the operations of 1004 may be performed by a UE as described with reference to FIG. 6.

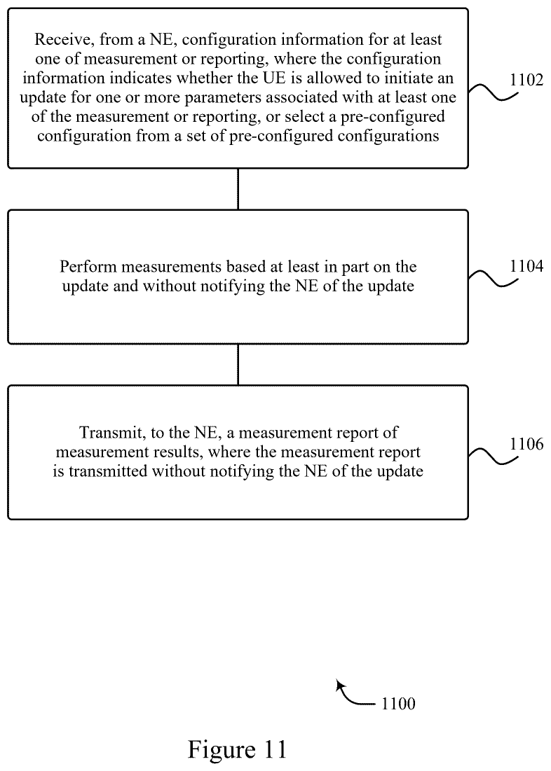

FIG. 11 illustrates a flowchart of a method 1100 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1102, the method may include receiving, from a NE, configuration information for at least one of measurement or reporting, where the configuration information indicates whether the UE is allowed to initiate an update for one or more parameters associated with at least one of the measurement or reporting, or select a pre-configured configuration from a set of pre-configured configurations. The operations of 1102 may be performed in accordance with examples as described herein. In some implementations, aspects of the operations of 1102 may be performed by a UE as described with reference to FIG. 6.

At 1104, the method may include performing measurements based at least in part on the update and without notifying the NE of the update. The operations of 1104 may be performed in accordance with examples as described herein. In some implementations, aspects of the operations of 1104 may be performed by a UE as described with reference to FIG. 6.

At 1106, the method may include transmitting, to the NE, a measurement report of measurement results, where the measurement report is transmitted without notifying the NE of the update. The operations of 1106 may be performed in accordance with examples as described herein. In some implementations, aspects of the operations of 1106 may be performed a UE as described with reference to FIG. 6.

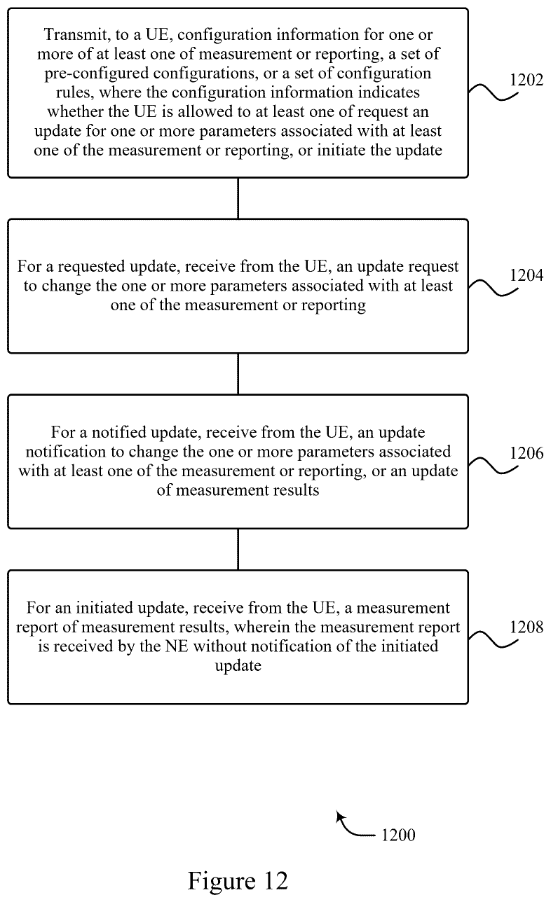

FIG. 12 illustrates a flowchart of a method 1200 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1202, the method may include transmitting, to a UE, configuration information for one or more of at least one of measurement or reporting, a set of pre-configured configurations, or a set of configuration rules, where the configuration information indicates whether the UE is allowed to at least one of request an update for one or more parameters associated with at least one of the measurement or reporting, or initiate the update. The operations of 1202 may be performed in accordance with examples as described herein. In some implementations, aspects of the operations of 1202 may be performed by a NE as described with reference to FIG. 8.

At 1204, the method may include, for a requested update, receive from the UE, an update request to change the one or more parameters associated with at least one of the measurement or reporting. The operations of 1204 may be performed in accordance with examples as described herein. In some implementations, aspects of the operations of 1204 may be performed by a NE as described with reference to FIG. 8.

At 1206, the method may include, for a notified update, receive from the UE, an update notification to change the one or more parameters associated with at least one of the measurement or reporting, or an update of measurement results. The operations of 1206 may be performed in accordance with examples as described herein. In some implementations, aspects of the operations of 1206 may be performed a NE as described with reference to FIG. 8.

At 1208, the method may include, for an initiated update, receive from the UE, a measurement report of measurement results, where the measurement report is received by the NE without notification of the initiated update. The operations of 1208 may be performed in accordance with examples as described herein. In some implementations, aspects of the operations of 1208 may be performed a NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive, from a network equipment (NE), configuration information for at least one of measurement or reporting, wherein the configuration information indicates whether the UE is allowed to request an update for one or more parameters associated with at least one of the measurement or reporting; and
transmit, to the NE, an update request to change the one or more parameters associated with at least one of the measurement or reporting.

2. The UE of claim 1, wherein the at least one processor is operable to cause the UE to receive, from the NE, updated configuration information based at least in part on the update request, the updated configuration information for at least one of updated measurement or updated reporting.

3. The UE of claim 1, wherein:
the UE has a set of pre-configured configurations; and
the at least one processor is operable to cause the UE to:
select a pre-configured configuration from the set of pre-configured configurations; and
transmit the update request associated with the selected pre-configured configuration.

4. The UE of claim 3, wherein the at least one processor is operable to cause the UE to:
select the pre-configured configuration from the set of pre-configured configurations based at least in part on current measurement results; and
transmit the update request indicating the selected pre-configured configuration.

5. The UE of claim 1, wherein the update request indicates a change in periodicity of reporting measurement results.

6. The UE of claim 1, wherein the at least one processor is operable to cause the UE to transmit, to the NE, a measurement report of measurement results and a validity period associated with the measured results, wherein the validity period is a time duration after which the UE expects a change in reported measurement results.

7. The UE of claim 1, wherein the at least one processor is operable to cause the UE to transmit, to the NE, a measurement report of measurement results and a confidence value that indicates a likelihood of change in subsequent measurement results.

8. A user equipment (UE) for wireless communication, comprising:
at least one memory; and
at least one processor coupled with the at least one memory and operable to cause the UE to:
receive, from a network equipment (NE), configuration information for at least one of measurement or reporting, wherein the configuration information indicates whether the UE is allowed to initiate an update for one or more parameters associated with at least one of the measurement or reporting; and
transmit, to the NE, at least one of an update notification to change the one or more parameters associated with at least one of the measurement or reporting, or a selection of a pre-configured configuration from a set of pre-configured configurations.

9. The UE of claim 8, wherein the at least one processor is operable to cause the UE to select the pre-configured configuration from the set of pre-configured configurations based at least in part on current measurement results.

10. The UE of claim 8, wherein:
the configuration information includes a timing delay; and
the at least one processor is operable to cause the UE to transmit, to the NE, the update notification, and wait a time duration of the timing delay before at least one of continuing measurements or reporting measurements results based at least in part on the update notification.

11. The UE of claim 10, wherein the at least one processor is operable to cause the UE to start a timer to wait the timing delay, wherein the timer is started based at least in part on a confirmation that the NE received the update notification.

12. The UE of claim 11, wherein the at least one processor is operable to cause the UE to receive hybrid automatic repeat request (HARQ) feedback as the confirmation that the NE received the update notification.

13. A user equipment (UE) for wireless communication, comprising:
at least one memory; and
at least one processor coupled with the at least one memory and operable to cause the UE to:
receive, from a network equipment (NE), configuration information for at least one of measurement or reporting, wherein the configuration information indicates whether the UE is allowed to initiate an update for one or more parameters associated with at least one of the measurement or reporting, or select a pre-configured configuration from a set of pre-configured configurations;
perform measurements based at least in part on the update and without notifying the NE of the update; and
transmit, to the NE, a measurement report of measurement results, wherein the measurement report is transmitted without notifying the NE of the update.

14. The UE of claim 13, wherein the configuration information includes a set of configuration rules by which the UE and the NE initiate the update.

15. The UE of claim 13, wherein:
the configuration information includes a timing delay;
the at least one processor is operable to cause the UE to:
perform the measurements based at least in part on the configuration information before the update; and
transmit, to the NE, an initial measurement report, and wait a time duration of the timing delay before at least one of continuing measurements or reporting measurement results based at least in part on the change notification.

16. The UE of claim 15, wherein the at least one processor is operable to cause the UE to start a timer to wait the timing delay, wherein the timer is started based at least in part on a confirmation that the NE received the initial measurement report.

17. The UE of claim 16, wherein the at least one processor is operable to cause the UE to receive hybrid automatic repeat request (HARQ) feedback as the confirmation that the NE received the initial measurement report.

18. A network equipment (NE) for wireless communication, comprising:
at least one memory; and
at least one processor coupled with the at least one memory and operable to cause the NE to:
transmit, to a user equipment (UE), configuration information for one or more of at least one of measurement or reporting, a set of pre-configured configurations, or a set of configuration rules, wherein the configuration information indicates whether the UE is allowed to at least one of request an update for one or more parameters associated with at least one of the measurement or reporting, or initiate the update; and one of:
for a requested update, receive from the UE, an update request to change the one or more parameters associated with at least one of the measurement or reporting;
for a notified update, receive from the UE, an update notification to change the one or more parameters associated with at least one of the measurement or reporting, or an update of measurement results; or
for an initiated update, receive from the UE, a measurement report of measurement results, wherein the measurement report is received by the NE without notification of the initiated update.

19. The NE of claim 18, wherein the update request or the update notification indicates whether the UE selected a pre-configured configuration from the set of pre-configured configurations.

20. The NE of claim 18, wherein the at least one processor is operable to cause the NE to determine, based at least in part on the measurement report and the set of configuration rules, that the UE updated the one or more parameters associated with at least one of the measurement or reporting, or selected a different pre-configured configuration from the set of pre-configured configurations.
